(19) United States
(12) Patent Application Publication
(10) Pub. No.: US 2016/0186920 A1
(43) Pub. Date: Jun. 30, 2016

(54) Central Post Reversion Device For A Tripod

(71) Applicant: Foshan Nanhai Chevan Optical Electronics Co., Ltd., Foshan (CN)

(72) Inventor: Li-Wha Lee, Foshan (CN)

(21) Appl. No.: 14/794,620

(22) Filed: Jul. 8, 2015

(30) Foreign Application Priority Data
Dec. 25, 2014 (CN) 201420842541.4

(51) Int. Cl. F16M 11/38; F16B 7/10

(52) U.S. Cl. CPC F16M 11/38; F16B 7/10; F16M 2200/022

(57) ABSTRACT

A central post reversion device for a tripod, including an upper protective cap, a lower protective cap, a left spherical shell and a right spherical shell and a central post finger used to telescope the central post, the upper protective cap is fixed on the lower protective cap to form, with the lower protective cap, a spherical receiving cavity with opening, the left spherical shell and the right spherical shell are placed into the spherical receiving cavity symmetrically, the central post finger is placed between and fixed by the left spherical shell and the right spherical shell.

### CROSS-REFERENCE TO RELATED APPLICATIONS

This application claims the benefit of CN Utility Model Application No. 201420842541.4, filed 25 Dec. 2014, the entire contents and substance of which are hereby incorporated by reference.

### BACKGROUND OF THE INVENTION

1. Field of the Invention

The invention relates generally to accessories for photographic equipments, and namely to a central post reversion device for a tripod.

2. Description of Related Art

In the prior art, when the tripod for photography is collapsed, the central post elements can only be placed at the most top of the protective cap of the tripod vertically, or only the three legs are reversed to collapse to the smallest size, which is not convenient to carry; at the same time, when the tripod is used for taking a photo at a lower angle or a close distance, it is very inconvenient to operate, which cannot reach to take photo at the lowest angle or the closest distance, affecting the effect of photographing.

### BRIEF SUMMARY OF THE INVENTION

The present invention, in order to conquer the shortcomings in the prior art, provides a central post reversion device for a tripod that can be rotated in the vertical direction at 180 degrees.

The present invention is realized by adopting the following technical solutions:

A central post reversion device for a tripod comprises an upper protective cap, a lower protective cap, a left spherical shell, a right spherical shell and a central post finger used to telescope the central post; the upper protective cap is fixed on the lower protective cap to form, with the lower protective cap, a spherical receiving cavity with an opening; the left spherical shell and the right spherical shell are placed in the spherical receiving cavity symmetrically; the central post finger is placed between and fixed by the left spherical shell and the right spherical shell.

Preferably, the central post reversion device for a tripod also comprises a locking structure that is fixed on the upper protective cap, with one end thereof being pressed against the left spherical shell or the right spherical shell; the central post is fixed by the locking structure, so that the central post cannot be pulled easily from the central post finger; the specific structure thereof is as following: the locking structure comprises a knob and a central post compact; the central post compact is placed between the upper protective cap and the left spherical shell or the right spherical shell, and is pressed on the side of the left spherical shell or the right spherical shell; the knob passes through the upper protective cap and is pressed on the central post compact; the knob is turned to adjust the force of the central post compact upon the left spherical shell or the right spherical shell to clamp or loosen the central post finger, so as to realize the fixing of the central post in the central post finger.

Preferably, the central post reversion device for a tripod further comprises a limiting structure that is installed at the bottom of the central post, which can prevent the drawing out of the central post from the central post finger; the specific structure thereof is as following: the limiting structure comprises a tail block, an elastic bean and an elastic member; the tail block is fixed at the bottom of the central post; the tail block is arranged with a slot hole horizontally in it; the elastic member is placed in the slot hole; the elastic bean is stuck at the opening of the slot hole and is connected with the outer end of the elastic member; because the elastic bean is stuck at the opening of the slot hole under the force of the elastic member, when the central post is pulled from the central post finger to the end, it will not leave the central post finger at the sticking function of the elastic bean.

Preferably, the upper protective cap is fixed on the lower protective cap through a screw(s).

Compared with the prior art, the advantageous effects of the present invention are, among other things: in the present utility mode, when the central post finger is fixed by the left spherical shell and the right spherical shell in the spherical receiving cavity formed by the upper protective cap and the lower protective cap, when the central post is pulled in the central post finger to its end, under the circumstance that the whole central post is not necessary to be pulled out, the central post swings in the vertical direction at 180 degrees, which places the central post at the lower end of the tripod, easy to collapse; at the same time, since the central post can be rotated, the photographer can take photos at a low angle or a close distance, improving quality of photographing. The present invention is of simple structure, easy operation, various functions and wide applicability.

These and other objects, features and advantages of the present invention will become more apparent upon reading the following specification in conjunction with the accompanying drawing figures.

### BRIEF DESCRIPTION OF THE DRAWINGS

Various features and advantages of the present invention may be more readily understood with reference to the following detailed description taken in conjunction with the accompanying drawings, wherein like reference numerals designate like structural elements, and in which:

FIG. 1 is a view of the structure of a central post reversion device for a tripod in the present invention;

FIG. 2 is a top view of the central post reversion device for a tripod in FIG. 1.

FIG. 3 is an exploded view of the structure of a central post reversion device for a tripod in the present invention;

FIG. 4 is a view of use status of a central post reversion device for a tripod in the present invention; and

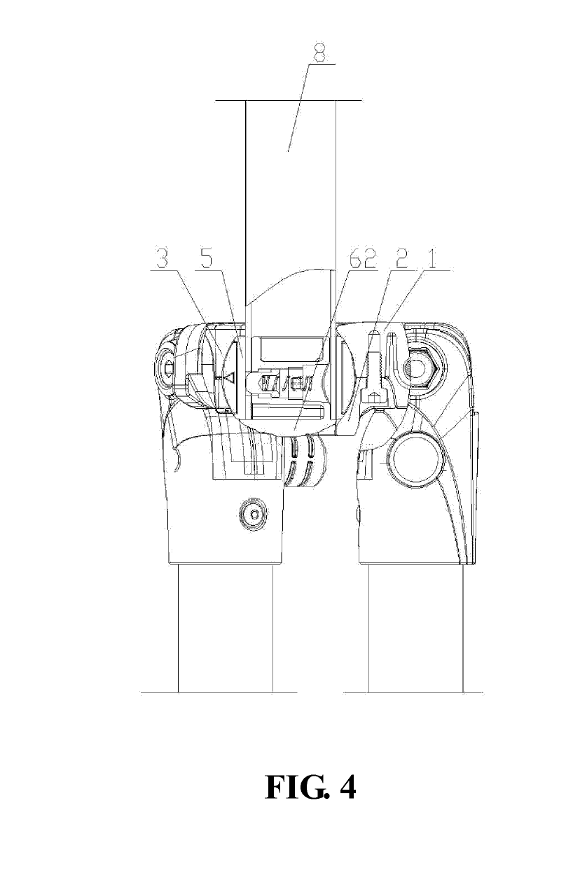

FIG. 5 is another view of use status of a central post reversion device for a tripod in the present invention.

### DETAILED DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

The following is a further description of the preferable embodiments of the present invention in combination with the figures.

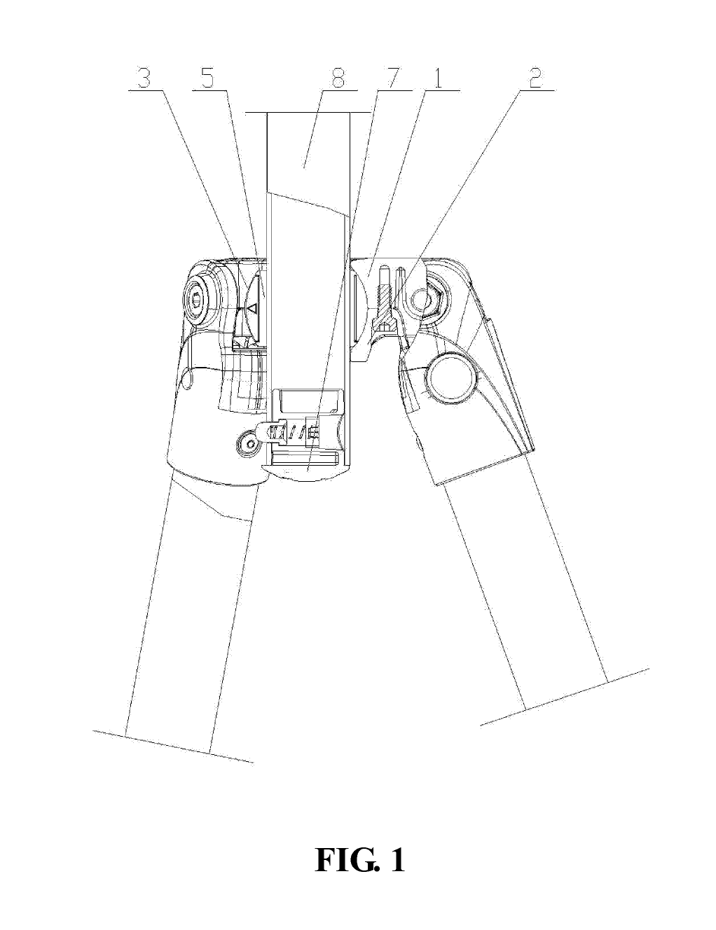

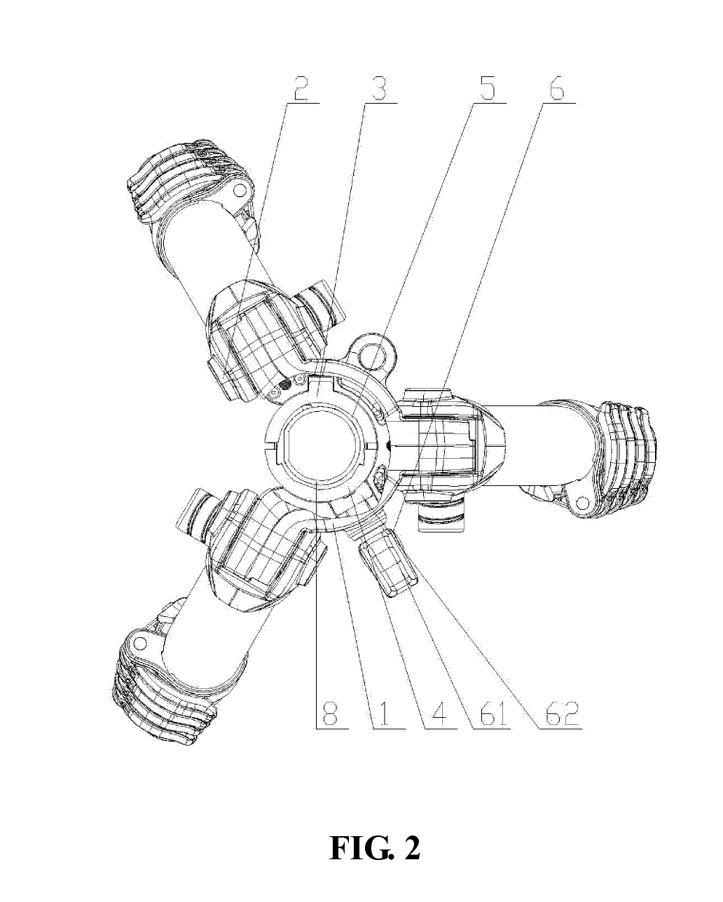

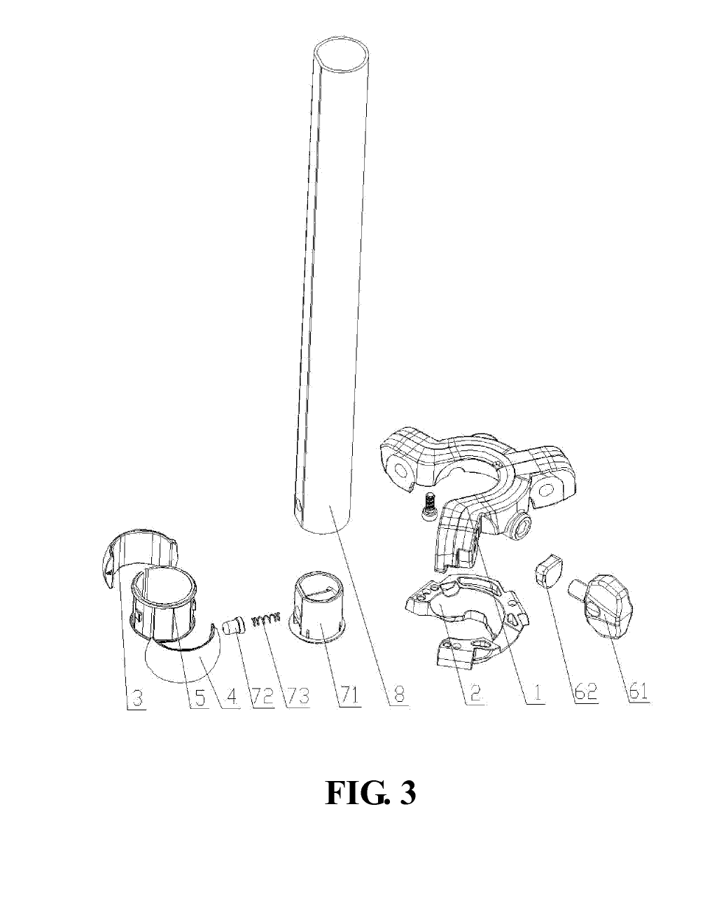

As shown in FIGS. 1 to 3, a central post reversion device for a tripod in this embodiment comprises an upper protective cap 1, a lower protective cap 2, a left spherical shell 3, a right spherical shell 4, a central post finger 5 used to telescope a central post 8, a locking structure 6, a limiting structure 7; the upper protective cap 1 is fixed on the lower protective cap 2 through fixing elements such as a screw, etc, to form, with the lower protective cap 2, a spherical receiving cavity with an opening; the left spherical shell 3 and the right spherical shell 4 are placed in the spherical receiving cavity symmetrically; the central post finger 5 is placed between and is fixed by the left spherical shell 3 and the right spherical shell 4; the locking structure 6 is fixed on the upper protective cap 1, with one end thereof being pressed against the left spherical shell 3 or the right spherical shell 4; the limiting structure 7 is installed at the bottom of the central post, wherein the locking structure 6 is used to fix the central post 8, so that the central post 8 cannot be pulled easily from the central post finger 5; the limiting structure 7 can prevent the drawing out of the central post 8 from the central post finger 5.

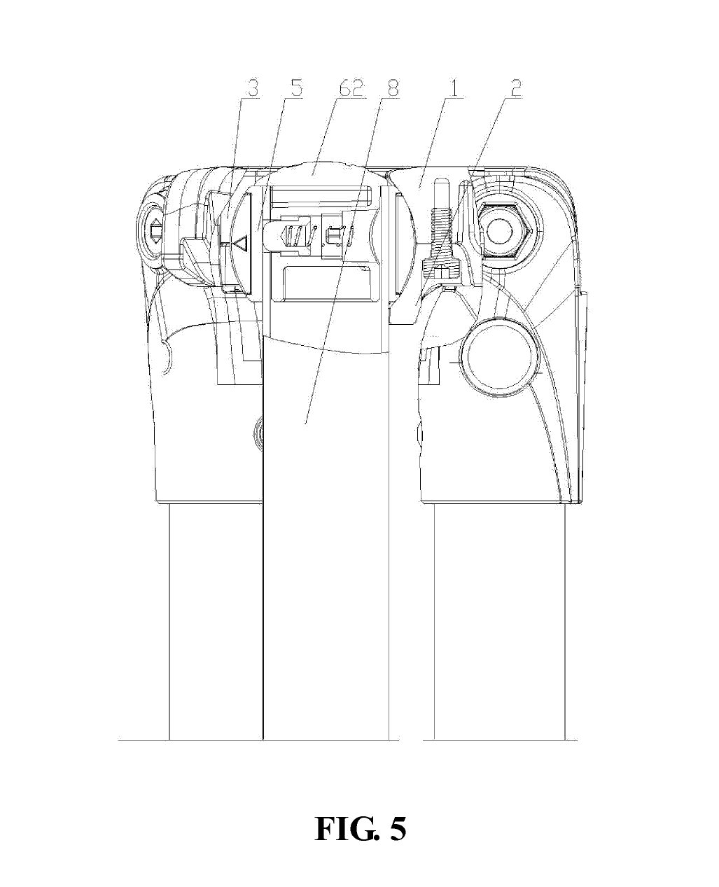

In a central post reversion device for a tripod of the present embodiment, when the central post finger 5 is fixed by the left spherical shell 3 and the right spherical shell 4 in the spherical receiving cavity formed by the upper protective cap 1 and the lower protective cap 2, when the central post 8 is pulled in the central post finger 5 to its end, as shown by FIG. 5, under the circumstance that the whole central post 8 is not necessarily to be pulled out, the central post 8 swings in the vertical direction at 180 degrees through the opening at the place of the upper protective cap 1 and the lower protective cap 2, as shown by FIG. 5, which places the central post 8 at the lower end of the tripod, easy to collapse; at the same time, since the central post 8 can be rotated, the photographer can take a photo at a low angle or a close distance, improving the quality of photographing.

In this embodiment, the locking structure 6 can adopt the following structure: the locking structure 6 comprises a knob 61 and a central post compact 62; the central post compact 62 is placed between the upper protective cap 1 and the left spherical shell 3 or the right spherical shell 4, and is pressed on the side of the left spherical shell 3 or the right spherical shell 4; the knob 61 passes through the upper protective cap 1 and is pressed on the central post compact 62; the knob 61 is turned to adjust the force of the central post compact 62 on the left or right spherical shell to clamp or loosen the central post finger, to further fix the central post 8 in the central post finger. Of course, the locking structure can also adopt other structures, as far as it can realize the function of locking the central post.

In this embodiment, a limiting structure 7 can adopt a structure as following: the limiting structure 7 comprises a tail block 71, an elastic bean 72 and an elastic member 73; the tail block 71 is a crown block having a diameter slightly larger than that of the central post; the elastic bean 72 is a cylinder or a ball, with a small hat-shaped block; the elastic member 73 is a spring-like member; the tail block 71 is fixed at the bottom of the central post 8; the tail block 71 is arranged with a slot hole horizontally in it; the elastic member 73 is placed in the slot hole; the elastic bean 72 is stuck at the opening of the slot hole and is connected with the outer end of the elastic member 73; because the elastic bean 72 is stuck at the opening of the slot hole under the force of the elastic member, when the central post 8 is pulled from the central post finger 5 to the end, the elastic bean 72 will not be separated from the central post finger 5 under the sticking function of the elastic bean 72. When it needs to reverse the central post 8, the elastic bean can be pressed to make the same 72 wholly enter into the slot hole; at this time, the central post 8 is pulled to make the tail block 71 tightly against the left spherical shell 3 and the right spherical shell 4, to form a ball shape with the two, and it can rotate in the spherical receiving cavity, enabling the central post 8 to swing in the vertical direction at 180 degree. Of course, the limiting structure 7 can also adopt other structures, as far as it can limit the central post from separating from the central post finger and is convenient to reverse the central post.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. A central post reversion device for a tripod comprising:
an upper protective cap;
a lower protective cap;
a left spherical shell;
a right spherical shell; and
a central post finger used to telescope a central post of a tripod;
wherein the upper protective cap is fixed on the lower protective cap to form, with the lower protective cap, a spherical receiving cavity with an opening;
wherein the left spherical shell and the right spherical shell are placed into the spherical receiving cavity symmetrically; and
wherein the central post finger is placed between and fixed by the left spherical shell and the right spherical shell.

2. The central post reversion device of claim 1 further comprising a locking structure that is fixed on the upper protective cap, with one end thereof being pressed against the left spherical shell or the right spherical shell.

3. The central post reversion device of claim 1 further comprising a limiting structure that is installed at the bottom of the central post.

4. The central post reversion device of claim 1, wherein the protective upper cap is fixed on the lower protective cap through one or more screws.

5. The central post reversion device of claim 2, wherein the locking structure comprises a knob and a central post compact;
wherein the central post compact is placed between the upper protective cap and the left spherical shell or the right spherical shell, and is pressed on the side of the left spherical shell or the right spherical shell; and
wherein the knob passes through the upper protective cap and is pressed on the central post compact.

6. The central post reversion device of claim 2 further comprising a limiting structure that is installed at the bottom of the central post.

7. The central post reversion device of claim 2, wherein the protective upper cap is fixed on the lower protective cap through one or more screws.

8. The central post reversion device of claim 5, wherein the limiting structure comprises:
a tail block;
an elastic bean; and
an elastic member;
wherein the tail block is fixed at the bottom of the central post;
wherein the tail block is arranged with a slot hole horizontally in it;
wherein the elastic member is placed in the slot hole; and
wherein the elastic bean is stuck at the opening of the slot hole and is connected with the outer end of the elastic member.

9. The central post reversion device of claim 5 further comprising a limiting structure that is installed at the bottom of the central post.

10. The central post reversion device of claim 5, wherein the protective upper cap is fixed on the lower protective cap through one or more screws.

11. The central post reversion device of claim 6, wherein the limiting structure comprises:
a tail block;
an elastic bean; and
an elastic member;
wherein the tail block is fixed at the bottom of the central post;
wherein the tail block is arranged with a slot hole horizontally in it;
wherein the elastic member is placed in the slot hole; and
wherein the elastic bean is stuck at the opening of the slot hole and is connected with the outer end of the elastic member.

12. The central post reversion device of claim 9, wherein the limiting structure comprises:
a tail block;
an elastic bean; and
an elastic member;
wherein the tail block is fixed at the bottom of the central post;
wherein the tail block is arranged with a slot hole horizontally in it;
wherein the elastic member is placed in the slot hole; and
wherein the elastic bean is stuck at the opening of the slot hole and is connected with the outer end of the elastic member.
